(19) United States
(12) Patent Application Publication
(10) Pub. No.: US 2018/0010079 A1
(43) Pub. Date: Jan. 11, 2018

(54) LIQUID DETERGENT COMPOSITION

(71) Applicant: The Procter & Gamble Company, Cincinnati, OH (US)

(72) Inventors: Francesco DE BUZZACCARINI, Breendonk (BE); Hugo Robert Germain DENUTTE, Hofstade (BE); Patrick Willy Maurits GOETHALS, Eeklo (BE)

(21) Appl. No.: 15/643,519

(22) Filed: Jul. 7, 2017

(30) Foreign Application Priority Data
Jul. 8, 2016 (EP) 16178534.0

(51) Int. Cl. C11D 3/50; C11D 1/83; C11D 17/04; C11D 3/30; C11D 1/22; C11D 1/72

(52) U.S. Cl. CPC C11D 3/50; C11D 17/043; C11D 3/30; C11D 1/83; C11D 1/72; C11D 1/22

(57) ABSTRACT

A liquid detergent composition having a perfume oil comprising perfume raw material selected from the group consisting of: aldehyde, ketone, ketals, and mixtures thereof, and a hindered primary amine, having improved colour and odour.

### FIELD OF THE INVENTION

The present invention relates to a liquid detergent composition and to a unit dose article comprising a liquid detergent composition having improved colour and odour.

### BACKGROUND OF THE INVENTION

Consumer products may comprise perfume oils that provide a desired scent to a product and/or a surface treated with the product. The perfume oils comprise one or more perfume raw materials.

In the context of liquid detergent compositions, the incorporation of perfume oils or perfume delivery systems can lead to a formulation stability issue. Specifically, some of the perfume raw materials that are contained within the perfume oil or within the perfume delivery system can react with alkanolamines which conventionally are used as a neutralizing agent in the liquid detergent composition or to provide alkalinity to the composition.

The instability is often seen as a colour change in the composition and/or a change in the olfactory character of the perfume oil. This change in colour and/or character is perceived by consumers as negative characteristics.

Thus, there is a need for a stable liquid detergent composition comprising perfume oil and a source of alkalinity, that has improved colour and odour stability.

### SUMMARY OF THE INVENTION

The present invention relates to a liquid detergent composition comprising: surfactant; perfume oil comprising perfume raw material selected from the group consisting of: aldehyde, ketone, ketals, and mixtures thereof; and a hindered primary amine

### DETAILED DESCRIPTION OF THE INVENTION

The primary amine, when used in the composition of the present invention comprising perfume raw materials selected from aldehydes, ketones, ketals, and mixtures thereof, has been surprisingly found to result in less discoloration

As used herein, the term “detergent product” means a product relating to cleaning or treating: fabrics, hard or soft surfaces, skin, hair, or any other surfaces in the area of fabric care, home care, skin care, and hair care. The detergent products include, but are not limited to: laundry detergent, laundry detergent additive, carpet cleaner, floor cleaner, bathroom cleaner, toilet cleaner, sink cleaner, dishwashing detergent, car cleaners, skin cleanser, shaving cream, hair shampoo, and the like.

As used herein, the term “liquid composition” refers to detergent compositions that are in a form selected from the group consisting of liquid, gel, cream, and combinations thereof. The liquid detergent composition may be either aqueous or non-aqueous.

As used herein, the term “perfume oil” refers to free, volatile oils comprising one or more perfume raw materials (PRMs) and optional solvents. The PRMs are free to become volatized and available for olfactory detection by a user. The term “perfume delivery system” herein refers to the combination or reaction product of PRMs with certain chemical compounds, which enhances the deposition efficiency of the perfume onto a surface and/or a controlled release of the perfume. The term “perfume” herein is a general term that could refer to PRM, perfume delivery system, perfume oil, or a pleasant scent achieved thereby. The terms “scent” and “odor” are synonymous.

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

### Liquid Detergent Composition

The liquid composition can include solids or gases in, but the liquid composition excludes forms which are non-liquid overall, such as tablets or granules. The liquid detergent compositions preferably have densities in the range from of 0.9 to 1.3 grams per cubic centimeter, more preferably from 1.00 to 1.1 grams per cubic centimeter, excluding any solid additives, but including any bubbles, if present.

The composition can comprise less than 40 wt % of water, or from 0.5% to 20%, preferably 3% to 15%, more preferably from 5% to 10% by weight of the composition of water, especially when encapsulated in water-soluble or dispersible film to form unit dose articles.

The liquid detergent composition herein may be acidic or alkaline or pH neutral, depending on the ingredients incorporated in the composition. The pH range of the liquid detergent composition is preferably from 5 to 13, more preferably from 6 to 11, even more preferably from 6.5 to 8.

When used in water-soluble or water-dispersible unit dose articles, an alkaline composition (e.g., with a pH of from 7 to 11) is preferred due to being more compatible with the water-soluble film of the article, e.g., a polyvinyl alcohol film.

The pH is measured on the composition diluted to 10% in water, at 25° C., using a Sartarius PT-10P pH meter with gel-filled probe (such as the Toledo probe, part number 52 000 100), calibrated according to the instructions manual.

### Perfume Oil

The liquid detergent composition comprises a perfume oil. The perfume oil comprises perfume raw material selected from the group consisting of: aldehydes, ketones, ketals, and mixtures thereof, preferably aldehyde, ketone, and mixtures thereof, more preferably aldehydes and mixtures thereof.
The perfume raw material can be selected from the group consisting of: 2,6,10-trimethylundec-9-enal, citronellyl oxyacetaldehyde, 3-(4-propan-2-ylphenyl)propanal, Hexyl cinnamic aldehyde, amyl Cinnamic aldehyde, butyl Cinnamic aldehyde, 3-(1,3-benzodioxo-5-yl)-2-methylpropanal, 3-(4-methyl-1-cyclohex-3-enyl)butanal, melonal, 4-(4-2-(4-methylphenyl)methylene-heptenal, methylpent-3-enyl)cyclohex-3-ene-1-carbaldehyde, 2,4-dimethyl-3-cyclohexene-1-carboxaldehyde, 1-methyl-4-(4-methylpentyl)cyclohex-3-ene-1-carbaldehyde, 8,8-dimethyl-6,7-dihydro-5H naphthalene-2-carbaldehyde, decyl aldehyde, nonyl aldehyde, nonadienal, octyl aldehyde, undecyl aldehyde, undecylenic aldehyde, methyl nonyl acetaldehyde, 3-(4-tert-butylphenyl)propanal, 3-(4-methoxyphenyl)-2-methylpropanal, citral, dodecylaldehyde, 3-(3-propan-2-ylphenyl)butanal, 1-(5,5-dimethyl-1-cyclohexenyl)pent-4-en-1-one, delta damascone, alpha damascone, damascenone, 5-methylhept-2-en 4-one, 6-methylhept-5-en 2-one, 2-[2-(4-methyl-1-cyclohex-3-enyl)propyl]cyclopentan-1-one, ionone alpha, beta ionone, beta damascone, iso damascone, vanillin, ethyl vanillin, heliotropin diethyl acetal, citral dimethyl acetal, citral diethyl acetal, vanillin propylene glycol acetal, vanillin butanediol acetal, ethyl vanillin propylene glycol acetal and mixtures thereof
Preferably, the perfume raw material is selected from the group consisting of: 2,6,10-trimethylundec-9-enal, citronellyl oxyacetaldehyde, 3-(4-propan-2-ylphenyl)propanal, Hexyl cinnamic aldehyde, amyl Cinnamic aldehyde, butyl Cinnamic aldehyde, 3-(1,3-benzodioxol-5-yl)-2-methylpropanal, 2-(4-methylphenyl)methylene-heptenal, 3-(4-methyl-1-cyclohex-3-enyl)butanal, melonal, 4-(4-methylpent-3-enyl)cyclohex-3-ene-1-carbaldehyde, 2,4-dimethyl-3-cyclohexene-1-carboxaldehyde, 1-methyl-4-(4-methylpentyl)cyclohex-3-ene-1-carbaldehyde, 8,8-dimethyl-6,7-dihydro-5H naphthalene-2-carbaldehyde, decyl aldehyde, nonyl aldehyde, nonadienal, octyl aldehyde, undecyl aldehyde, undecylenic aldehyde, methyl nonyl acetaldehyde, 3-(4-tert-butylphenyl)propanal, 3-(4-methoxyphenyl)-2-methylpropanal, citral, dodecylaldehyde, 3-(3-propan-2-ylphenyl)butanal, 1-(5,5-dimethyl-1-cyclohexenyl)pent-4-en-1-one, delta damascone, alpha damascone, damascenone, 5-methylhept-2-en 4-one, 6-methylhept-5-en 2-one, 2-[2-(4-methyl-1-cyclohex-3-enyl)propyl]cyclopentan-1-one, ionone alpha, beta ionone, beta damascone, iso damascone, vanillin, ethyl vanillin, and mixtures thereof,
More preferably, the perfume raw material is selected from the group consisting of: para hydroxy phenyl butanone, anisic aldehyde, ethyl vanillin, citral, triplal, heliotropin, vanillin isobutyrate, melonal, and mixtures thereof.
As mentioned earlier, such perfume raw materials can react with alkanolamines which may result in discoloration of the liquid detergent composition.
The liquid composition can comprises said perfume oil at a level of from 0.005 to 2.5 wt %, preferably 0.015 to 2.0 wt %, more preferably from 0.03 to 1.0 wt % of the composition
The perfume oil can comprise aldehydes selected from the group consisting of: α-β unsaturated aldehydes, aromatic aldehydes, and mixtures thereof, at a level of from 0.1 to 80 wt %, preferably from 0.5 to 20 wt %, more preferably from 0.5 to 10 wt % of the composition. α-β unsaturated aldehydes and aromatic aldehydes typically result in greater discoloration in the presence of alkanolamines.

### Primary Amine

The liquid detergent composition comprises a perfume oil. The perfume oil comprises perfume raw material selected from the group consisting of: aldehyde, ketone, ketals, and mixtures thereof. Such perfume raw materials typically react with alkanolamines resulting in discoloration of the liquid detergent composition. It has surprisingly been found that the discoloration is significantly reduced when primary amines, as described below, are used. It is believed that the primary amine group is sterically hindered by the alkyl groups, such that reaction with the perfume raw materials is limited.
Suitable primary amines have the structure:

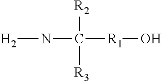

wherein:
R₁ is a CnH2n, wherein n is from 1 to 6, preferably n is from 1 to 3, more preferably n is 1,
R₂ is a C1 to C6 alkyl group,
R₃ is H or a C1 to C6 alkyl group.
   Preferably, R₂ and R₃ are both C1 to C6 alkyl groups. R₂ and R₃ can be independently C1 to C3 alkyl groups, preferably R₂ and R₃ are independently C1 alkyl groups. R₂ and R₃ can independently be substituted or unsubstituted alkyl groups. When substituted, hydroxyl substitutions are preferred. More preferably, R₂ and R₃ are unsubstituted alkyl groups. Preferably, the primary amine is 2-amino-2-methyl-1-propanol.
The primary amine can be present at a level of from 1 to 30 wt %, preferably 3 to 20 wt %, more preferably from 5 to 10 wt % of the composition.
The primary amine is typically added either to raise the pH to the desired level, for instance, for improved grease cleaning, or to neutralise surfactants, especially anionic surfactant.

The alkanolamine can be utilized to neutralize anionic surfactants, such as linear alkylbenzene sulfonate (LAS), or certain acidic ingredients, such as fatty acid and citric acid, thus achieving a preferred alkaline or neutral composition.

### Surfactant

The liquid detergent composition can comprise a surfactant selected from the group consisting of: anionic surfactant, nonionic surfactant, zwitterionic surfactant, and mixtures thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials. The anionic surfactant may be selected from linear alkyl benzene sulfonate, alkyl ethoxylate sulphate and combinations thereof.

Anionic surfactants can also include salts of saturated or unsaturated fatty acids derived from plants or animal sources, such as coconut oil, palm oil, tallow oil or similar oils.

The non-ionic surfactant may be selected from fatty alcohol alkoxylate, an oxo-synthesised fatty alcohol alkoxylate, Guerbet alcohol alkoxylates, alkyl phenol alcohol alkoxylates, amine oxide, alkyl polyglucosides surfactants, or a mixture thereof. Suitable nonionic surfactants for use herein include the alcohol alkoxylate nonionic surfactants. Suitable alcohol alkoxylates include materials which correspond to the general formula: R1(CₘH₂ₘO)ₙOH wherein R1 is a C8-C16 alkyl group, m is from 2 to 4, and n ranges from 2 to 12. R1 can be an alkyl group, which may be primary or secondary, which comprises from 9 to 15 carbon atoms, or from 10 to 14 carbon atoms. The alkoxylated fatty alcohols can be ethoxylated materials that contain on average from 2 to 12 ethylene oxide moieties per molecule, or from 3 to 10 ethylene oxide moieties per molecule.

Suitable amine oxide surfactants can have the formula: R₁R₂R₃NO wherein R1 is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R1 may be a saturated or unsaturated, substituted or unsubstituted linear or branched hydrocarbon chain.

Suitable amine oxides for use herein are for instance preferably C₁₂-C₁₄dimethyl amine oxide, commercially available from Albright & Wilson, C₁₂-C₁₄ amine oxides commercially available under the trade name Genaminox® LA from Clariant or AROMOX® DMC from AKZO Nobel.

Suitable zwitterionic surfactants include betaines such as cocamidopropyl betaine and sultaines such as cocamidopropylhydroxysultaine.

Surfactant can be present at a level of from 1 to 70wt %, preferably from 15 to 60 wt %, more preferably from 30 wt % to 50 wt % of the composition.

### Optional Ingredients

The liquid detergent composition of the present invention may comprise one or more optional ingredients. Suitable additional materials include but are not limited to: cationic surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, structure elasticizing agents, fabric softeners, carriers, hydrotropes, processing aids, solvents, hueing agents, anti-microbial agents, structurants and/or pigments. In addition to the disclosure below, suitable examples of such other adjuncts and levels of use are found in U.S. Pat. Nos. 5,576,282, 6,306,812, and 6,326,348. The precise nature of these additional ingredients and the levels thereof in the liquid detergent composition will depend on factors like the specific type of the composition and the nature of the cleaning operation for which it is to be used.

The composition may comprise between 1% and 45% by weight of the composition of an organic solvent, wherein the organic solvent preferably comprises glycerol, a diol, or a mixture thereof. The organic solvent may comprise glycerol and a diol, preferably wherein the diol is propandiol, and wherein the composition comprises from 0.1% to 30% by weight of glycerol and from 0.1% to 15% by weight of a diol.

In addition to the perfume oil, the liquid detergent composition herein may comprise other types of perfume delivery systems. Non-limiting examples of the perfume delivery systems suitable for use herein include the following: pro-perfume compounds, perfume microcapsule (PMC), cyclodextrin, zeolite & inorganic carrier, starch encapsulated accord, amine-assisted perfume delivery system (AAD), and polyacrylate capsule. Descriptions on these perfume delivery systems can be found in U.S. Patent Publication No. 2007/0275866 from paragraphs [0025] to [0030].

Such a combination of multiple types of perfume delivery systems allows the controlled release of a variety of different scent imparting substances, which is an advantage over slowly releasing just one perfume as will happen if just one perfume oil or perfume delivery system is used. For example, the composition of the present invention further comprises a PMC. The PMC comprises a wall material and a core material of PRM that is encapsulated within the wall material. The PRM is not being released from the PMC until the wall material ruptures because of a mechanical stress (e.g., friction), i.e., the perfume release from the PMC is at different time points from the free perfume oil.

The liquid detergent composition may further comprises a dye that imparts a colour to the composition. The incorporation of a dye can mask any remaining discoloration.

### Unit Dose Article

The liquid composition may be in the form of a unit dose article. The unit dose article of the present invention comprises a film which fully encloses the liquid composition in at least one compartment. Preferably, the film is water-soluble or water-dispersible.

The unit dose articles, preferably thermoformed articles, preferably comprise water-soluble or water-dispersible film, which envelop the composition contained therein. Preferably, the water-soluble or dispersible film comprises: polymers, copolymers, terpolymers, or derivatives thereof, including polyvinyl alcohols (PVA) or blends of polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum, or mixtures thereof. Preferably, the film comprises polyvinyl alcohols (PVA) or blends of polyvinyl alcohols. The films may also comprise plasticizers such as glycerin, diglycerin, sorbitol, ethylene glycol, diethylene glycol, triethylene glycol, tetraethylene glycol, propylene glycol, polyethylene glycols up to 400 MW, neopentyl glycol, trimethylolpropane, polyether polyols, sorbitol, 2-methyl-1,3-propanediol, ethanolamines, and a mixture thereof. Examples of suitable films include those commercially available from MonoSol (Merrillville, Ind., USA), such as M8630 or M8900, and those described in U.S. Patent Application 2011/0188784A1, assigned to the Procter & Gamble Company.

The unit dose article may comprise at least two films, or even at least three films, wherein the films are sealed together.

The unit dose article may optionally comprise additional compartments; said additional compartments may comprise an additional composition. Said additional composition may be liquid, solid, or mixtures thereof. Alternatively, any additional solid component may be suspended in a liquid-filled compartment. Each compartment may have the same or different compositions. A multi-compartment unit dose form may be desirable for such reasons as: separating chemically incompatible ingredients; or where it is desirable for a portion of the ingredients to be released into the wash earlier or later. The unit dose article comprises at least one, or even at least two, or even at least three, or even at least four, or even at least five compartments.

The film of the unit dose article is soluble or dispersible in water, and preferably has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water at 21° C. is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

The film may comprise a bittering agent, such as Bitrex.

### Composition Preparation

The liquid detergent composition of the present invention is generally prepared by conventional methods such as those known in the art of making liquid detergent compositions. Such methods typically involve mixing the essential and optional ingredients in any desired order to a relatively uniform state, with or without heating, cooling, application of vacuum, and the like, thereby providing liquid detergent compositions containing ingredients in the requisite concentrations. The process may be continuous or intermittent. The process comprises the general steps of forming an open article, preferably by forming a water-soluble film into a mould to form said open article, filling the open article with a composition, closing the open article filled with a composition, preferably using a second water-soluble film to form the unit dose article. Alternatively, the second film may be a second closed article containing one or more compartments, used to close the open article. Preferably, the process is one in which a web of unit dose article are made, said web is then cut to form individual unit dose articles.

### Test Methods

### pH Measurement

The pH is measured on the composition diluted to 10 wt % in water, at 25° C., using a Santarius PT-10P pH meter with gel-filled probe (such as the Toledo probe, part number 52 000 100), calibrated according to the instructions manual.

### EXAMPLES

Perfume composition A was prepared. The perfume composition comprised the following levels of aldehyde, ketone and ketal:

| | |
|---|---|
| Total aldehyde, and ketone perfume raw materials | 80 wt % |
| Total aldehyde perfume raw materials | 70 wt % |
| Total ketone perfume raw materials | 10 wt % |
| Total α-β unsaturated aldehydes | 10 wt % |
| Total aromatic aldehydes | 40 wt % |

The perfume composition was formulated into the following hard surface cleaning compositions. Example 1 was a composition of the present invention, comprising 2-amino-2-methyl 1-propanol at a level to result in a pH of 7.5. Comparative examples A and B comprised alternative amines at a level to provide the same final pH. The compositions were aged at 50° C. in darkness before the colour change was visually determined.
As can be seen from the colour after aging, the use of the hindered primary amines in the compositions of the present invention, results in much less discoloration than when alternative amines are used.

| | Ex 1 | Ex A* | Ex B* |
|---|---|---|---|
| | wt % | wt % | wt % |
| Ethoxylated nonionic | 29 | 29 | 29 |
| surfactant | | | |
| Linear alkylbenzene | 7 | 7 | 7 |
| sulphonic acid (HLAS) | | | |
| Fatty acid | 4 | 4 | 4 |
| C12-14 Alkyl Dimethyl | 2.5 | 2.5 | 2.5 |
| Anime Oxide | | | |
| Yellow dye mix | 0.01 | 0.01 | 0.01 |
| Organic solvent | 46.2 | 47.1 | 46.7 |
| Perfume composition A | 2.9 | 2.9 | 2.9 |
| 2-amino-2-methyl 1-propanol | 2.33 | — | — |
| 1-amino-2-propanol | — | 1.91 | — |
| Monethanolamine | — | — | 1.54 |
| Water | 6.1 | 6.1 | 6.0 |
| Minors | to 100% | to 100% | to 100% |
| pH | 7.5 | 7.5 | 7.5 |
| Colour | minor | significant | significant |
| | discoloration | discoloration | discoloration |
| | (orange) | (dark brown) | (dark brown) |

*comparative

The following are non-limiting examples of detergent compositions of the present invention, prepared by simple mixing:

| | Ex 2 | Ex 3 | Ex 4 | Ex 5 | Ex 6 | Ex 7 | Ex 8 | Ex 9 | Ex 10 |
|---|---|---|---|---|---|---|---|---|---|
| | wt % | wt % | wt % | wt % | wt % | wt % | wt % | wt % | wt % |
| Linear alkylbenzene | 8.0 | 5.0 | 13 | 0.0 | 0.0 | 0.0 | 9.0 | 19 | 11 |
| sulfonic acid | | | | | | | | | |
| Sodium C13-15 alkyl | — | — | — | — | — | — | — | — | 5.0 |
| 3ethoxy sulfate | | | | | | | | | |
| C8-10 alkyl 10ethoxylate | 20 | 27 | 37 | — | — | 8.0 | 17 | — | — |
| C13-15 alkly 7-ethoxylate | 2.0 | — | 14 | — | — | — | — | 18 | 12 |
| C8-10alkyl polyglucoside | — | 2.0 | — | 8.0 | 0.0 | — | — | — | — |
| C12alkyl dimethylamine N- | — | 1.0 | — | — | — | 1.0 | 1.5 | — | — |
| oxide | | | | | | | | | |
| C12 amidopropoyl | — | — | — | — | 9.5 | — | — | — | — |
| hydroxysultain | | | | | | | | | |
| C12-18 fatty acid | 4.0 | 3.0 | 6.0 | 0.0 | 0.0 | 0.0 | 3.0 | 15 | 9.0 |
| C16-18 alkyl dimethyl (2- | — | — | — | 1.5 | 5.0 | 1.5 | — | — | — |
| hydroxyethyl) | | | | | | | | | |
| ammoniumchloride | | | | | | | | | |
| Citric acid | 0.5 | 1.0 | 0.9 | — | 0.2 | — | 2.5 | 1.5 | 3.5 |
| detergent enzymes | — | — | — | — | — | — | | 1.5 | 2.5 |
| Phosphonate chelant | — | 0.2 | — | | 0.1 | — | 0.5 | 0.8 | 1.5 |
| Glycerol | 22 | 15 | — | 28 | 12 | — | — | 8.5 | |
| 1,2 propandiol | 22 | 25 | — | | 15 | 15 | 12 | 14 | 9.0 |
| Dipropyleneglycol | 7.0 | 9.0 | — | 2.0 | 5.0 | 9.0 | — | 3.0 | 4.0 |
| n-Butyl diglycol ether | 3.0 | — | — | 35 | 31 | 22 | 13 | — | — |
| Perfume oil | 2.7 | 2.5 | 5.7 | 1.5 | 2.2 | 1.5 | 1.3 | 2.5 | 1.5 |
| 2-amino-2 methyl- | 3.7 | 3.3 | 6.0 | 17 | 14 | 14 | 6.5 | 10.2 | 9.6 |
| 1propanol | | | | | | | | | |
| water, dyes, minors | 5.1 | 6.0 | 17 | 7.5 | 6.0 | 28 | 34 | 6.0 | 31 |
| pH at 10% | 7.0 | 7.0 | 8.0 | 10.5 | 10.0 | 10.0 | 7.5 | 7.5 | 7.5 |

The following are non-limiting examples of laundry soluble unit dose compositions of the present invention. The compositions are dosed into cavities comprised on webs made of water-soluble film according to those disclosed in U.S. Patent Application 2011/0188784A1, and webs comprising M8630 water-soluble film, available from MonoSol LLC (Merrillville, Ind., USA):

| | Composition: | | |
|---|---|---|---|
| | 2 | 3 | 4 |
| Dosage (mL) | 20 | 34 | 25 |
| Ingredient (wt %) | | | |
| Linear C₉-C₁₅ Alkylbenzene | 20 | 20.0 | 22 |
| sulfonic acid | | | |
| C₁₂₋₁₄ alkyl 9-ethoxylate | 15 | 17.0 | 4 |
| Citric Acid | 1 | | 0.7 |
| Fatty acid | 8 | 13.0 | 6 |
| C12-14 alkyl ethoxy 3 sulfate | 9 | | 15 |
| Chelant | 1 | 0.6 | 2 |
| | (DTPA) | (EDDS) | (HEDP) |
| Ethoxysulfated Hexamethylene | 2 | 2.2 | |
| Diamine Dimethyl Quat Polymer | | | |
| Alkoxylated polyamine¹ | 5 | 5.0 | 4 |
| Enzymes | 0.5 | 0.3 | 0.2 |
| Structurant | 0.15 | | 0.1 |
| Brightener | — | 0.2 | 0.3 |
| Hueing dye² | — | 0.035 | 0.07 |
| Glycerol | 6 | 5 | 4 |
| 1,2 propanediol | 11 | 5 | 12 |
| dipropyleneglycol | — | — | 4 |
| Perfume composition A | 1.5 | 3.0 | 2.2 |
| Water | 10 | 10 | 9 |
| 2-amino-2-methyl-1-propanol | To pH 7.4 | To pH 8.0 | To pH 7.5 |
| Additives, Minors | To 100% | To 100% | To 100% |

¹Polyethylenimine (MW = 600) with 20 ethoxylate groups per —NH
²Alkyl ethoxylated thiophene hueing dye

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
a) surfactant;
b) perfume oil comprising perfume raw material selected from the group consisting of: aldehyde, ketone, ketals, and mixtures thereof;
c) primary amine having the structure: 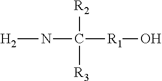
wherein:
R₁ is a CₙH₂ₙ, wherein n is from about 1 to about 6,
R₂ is a C1 to C6 alkyl group,
R₃ is H or a C1 to C6 alkyl group.

2. The liquid detergent composition according to claim 1, wherein in R₁ n is from about 1 to about 3.

3. The liquid detergent composition according to claim 1, wherein R₂ and R₃ are independently C1 to C3 alkyl groups.

4. The liquid detergent composition according to claim 1, wherein R₂ and R₃ are independently C1 alkyl groups.

5. The liquid detergent composition according to claim 3, wherein R₂ or R₃ are unsubstituted alkyl groups.

6. The liquid composition according to claim 1, wherein the primary amine is 2-amino-2-methyl-1-propanol.

7. The liquid composition according to claim 1, wherein the primary amine is present at a level of from about 1 to about 30 wt % of the composition.

8. The liquid composition according to claim 1, wherein the composition comprises said perfume raw material at a level of from about 0.005 to about 2.5 wt % of the composition.

9. The liquid composition according to claim 1, wherein the perfume oil comprises perfume raw material selected from the group consisting of: 2,6,10-trimethylundec-9-enal, citronellyl oxyacetaldehyde, 3-(4-propan-2-ylphenyl)propanal, Hexyl cinnamic aldehyde, amyl Cinnamic aldehyde, butyl Cinnamic aldehyde, 3(1,3-benzodioxo1-5-yl)-2-methylpropanal, 2-(4-methylphenyl)methylene-heptenal, 3-(4-methyl-1-cyclohex-3-enyl)butanal, melonal, 4-(4-methylpent-3-enyl)cyclohex-3-ene-1-carbaldehyde, 2,4-dimethyl-3-cyclohexene-1-carboxaldehyde, 1-methyl-4(4-methylpentyl)cyclohex-3-ene-1-carbaldehyde, 8,8-dimethyl-6,7-dihydro-5H naphthalene-2-carbaldehyde, decyl aldehyde, nonyl aldehyde, nonadienal, octyl aldehyde, undecyl aldehyde, undecylenic aldehyde, methyl nonyl acetaldehyde, 3-(4-tert-butylphenyl)propanal, 3-(4-methoxyphenyl)-2-methylpropanal, citral, dodecylaldehyde, 3-(3-propan-2-ylphenyl)butanal, 1-(5,5-dimethyl-1-cyclohexenyl)pent-4-en-1-one, delta damascone, alpha damascone, damascenone, 5-methylhept-2-en 4-one, 6-methylhept-5-en 2-one, 2-[2-(4-methyl-1-cyclohex-3-enyl)propyl]cyclopentan-1-one, ionone alpha, beta ionone, beta damascone, iso damascone, vanillin, ethyl vanillin, heliotropin diethyl acetal, citral dimethyl acetal, citral diethyl acetal, vanillin propylene glycol acetal, vanillin butanediol acetal, ethyl vanillin propylene glycol acetal and mixtures thereof.

10. The liquid composition according to claim 9, wherein the perfume raw material is selected from the group consisting of: 2,6,10-trimethylundec-9-enal, citronellyl oxyacetaldehyde, 3-(4-propan-2-ylphenyl)propanal, Hexyl cinnamic aldehyde, amyl Cinnamic aldehyde, butyl Cinnamic aldehyde, 3-(1,3-benzodioxo1-5-yl)-2-methylpropanal, 2-(4-methylphenyl)methylene-heptenal, 3-(4-methyl-1-cyclohex-3-enyl)butanal, melonal, 4-(4-methylpent-3-enyl)cyclohex-3-ene-1-carbaldehyde, 2,4-dimethyl-3-cyclohexene-1-carboxaldehyde, 1-methyl-4(4-methylpentyl)cyclohex-3-ene-1-carbaldehyde, 8,8-dimethyl-6,7-dihydro-5H naphthalene-2-carbaldehyde, decyl aldehyde, nonyl aldehyde, nonadienal, octyl aldehyde, undecyl aldehyde, undecylenic aldehyde, methyl nonyl acetaldehyde, 3-(4-tert-butylphenyl)propanal, 3-(4-methoxyphenyl)-2-methylpropanal, citral, dodecylaldehyde, 3-(3-propan-2-ylphenyl)butanal, 1-(5,5-dimethyl-1-cyclohexenyl)pent-4-en-1-one, delta damascone, alpha damascone, damascenone, 5-methylhept-2-en 4-one, 6-methylhept-5-en 2-one, 2-[2-(4-methyl-1-cyclohex-3-enyl)propyl]cyclopentan-1-one, ionone alpha, beta ionone, beta damascone, iso damascone, vanillin, ethyl vanillin, and mixtures thereof.

11. The liquid composition according to claim 10, wherein the perfume raw material is selected from the group consisting of: para hydroxy phenyl butanone, anisic aldehyde, ethyl vanillin, citral, triplal, heliotropin, vanillin isobutyrate, melonal, and mixtures thereof.

12. The liquid composition according to claim 1, wherein the perfume oil comprises perfume raw material selected from the group consisting of: aldehydes, ketones, and mixtures thereof.

13. The liquid composition according to claim 1, wherein said perfume oil comprises aldehydes selected from the group consisting of: α-β unsaturated aldehydes, aromatic aldehydes, and mixtures thereof at a level from about 0.1 to about 80 wt % of the composition.

14. The liquid composition according to claim 13, wherein said perfume oil is present at a level from about 0.5 to about 10 wt %.

15. The liquid detergent composition according to claim 1, wherein the composition has a pH of from about 5 to about 13.

16. The liquid detergent composition according to claim 1, wherein the surfactant is selected from the group consisting of: anionic surfactant, nonionic surfactant, zwitterionic surfactant, and mixtures thereof.

17. The liquid detergent composition according to claim 1, wherein the surfactant is present at a level of from about 1 to about 70 wt % of the composition.

18. The liquid detergent composition according to claim 1, wherein the composition comprises less than about 40 wt % of water.

19. The liquid detergent composition according to claim 18, wherein the composition comprises from 5 wt % to 10 wt % of water.

20. A unit dose article comprising the liquid detergent composition according to claim 18, wherein the liquid detergent composition is encapsulated in a water-soluble or water-dispersible film.
